(19) United States
(12) Patent Application Publication
(10) Pub. No.: US 2011/0008047 A1
(43) Pub. Date: Jan. 13, 2011

(54) DEVICE AND A METHOD FOR MANAGING THE TRANSMISSION POWER OF AN OPTICAL SOURCE ACCORDING TO THE LEVEL OF OPTICAL LOSSES OF AN OPTICAL LINK

(75) Inventors: Julien Poirrier, Locquemeau (FR); Franck Payoux, Bagneux (FR); Philippe Chanclou, Lannion (FR)

Correspondence Address: WESTMAN CHAMPLIN & KELLY, P.A., SUITE 1400, 900 SECOND AVENUE SOUTH, MINNEAPOLIS, MN, 55402, US

(73) Assignee: FRANCE TELECOM, Paris (FR)

(21) Appl. No.: 12/920,055

(22) PCT Filed: Feb. 26, 2009
(86) PCT No.: PCT/FR2009/050308

§ 371 Date: Aug. 27, 2010

(30) Foreign Application Priority Data
Feb. 28, 2008 (FR) 0851292

(51) Int. Cl. H04J 14/00; H04B 10/04

(52) U.S. Cl. 398/70; 398/192

(57) ABSTRACT

A device and method are provided for transmitting an optical signal including at least two optical components to be transmitted respectively through at least two optical links that can be established respectively between the transmission device and at least two terminal devices. The transmission device and method associate, based on at least one parameter representative of the optical losses of the optical links, at least one of the optical components to at least one optical link selected from the optical links and to a transmission optical power.

### CROSS-REFERENCE TO RELATED APPLICATIONS

This Application is a Section 371 National Stage Application of International Application No. PCT/FR2009/050308, filed Feb. 26, 2009 and published as WO 2009/112767 on Sep. 17, 2009, not in English.

### STATEMENT REGARDING FEDERALLY SPONSORED RESEARCH OR DEVELOPMENT

None.

### THE NAMES OF PARTIES TO A JOINT RESEARCH AGREEMENT None.

### FIELD OF THE DISCLOSURE

The field of the disclosure is that of telecommunications, more particularly that of access networks of the passive optical network (PON) type.

### BACKGROUND OF THE DISCLOSURE

A passive optical network is a point-to-multipoint tree network. One such network is represented in FIG. 1. At a first end, the network includes an optical line termination (OLT), generally located in an optical central office (OC), and having an output that is connected to a first end of an optical fiber 12. A second end of the optical fiber 12 is connected to the input of at least one wavelength multiplexer 13 with N interfaces enabling N wavelengths to be multiplexed/demultiplexed, N representing the number of links in the network. A first end of an optical fiber 14ⱼ, j ∈ {1, 2, . . . , N}, is connected to one of the N outputs of the multiplexer 13. A second end of the optical fiber 14ⱼ is connected to an optical network unit ONUᵢ, i ∈ {1, 2, . . . , N}, to which one or more users are connected. The optical central office OC includes a plurality of lasers each transmitting a wavelength that is specific to it and that are used to convey data to users connected to the network. In an optical network of this kind, each optical network unit is associated with an optical component of the optical central office and therefore with a particular wavelength. Finally, the optical central office also includes receiver means R for receiving signals transmitted by the optical network units.

The passive optical network described above uses wavelength-division multiplexing (WDM).

In such a passive optical network, the lasers at the optical central office transmit optical components with the same transmission power regardless of the wavelength associated with the optical component.

For each link of the network, the optical power difference between the transmission optical power of the laser at the optical central office and the optical power received by the receiver means in the optical network units represents the level of optical losses of a link.

The optical links of an optical access network can have different levels of optical losses. This is because the optical links do not all have the same length, are not all the same age, etc. Each optical link has a level of optical losses that is specific to it.

Consequently, the equal transmission power at the central office between the optical components and thus between the optical links is not reflected in an equal reception power at the optical network units, because of the different levels of optical losses of the optical links. This reception power difference between users of the same optical access network may be reflected in a disparity in terms of quality of service.

Thus there exists a requirement for a solution that offers users of the same optical access network the same quality of service.

### SUMMARY

The inventors of the present patent application address this requirement by proposing a device for transmitting an optical signal comprising at least two optical components intended to be transmitted over at least two respective optical links that can be set up between the transmitter device and at least two respective optical network units.

Such a device is noteworthy in that it includes means for associating at least one of the optical components, according to at least one parameter representing optical losses of the optical links with:

at least one optical link chosen from said optical links; and

a transmission optical power.

Thus, if Lᵢ represents a link, λᵢ represents an optical component of the optical signal, and Pᵢ denotes a transmission optical power, an embodiment of the invention includes constructing the optimum triplet (λᵢ, Pᵢ, Lᵢ) according to the level of optical losses in an optical link Lᵢ. Thus it is possible to provide the same quality of service to all users connected to the transmitting device whatever the level of optical losses of the optical links connecting them to the transmitting device or to increase the number of users connected to the transmitting device. Each optical link sends to the optical network unit that is connected to it an optical component associated with a transmission optical power adapted to the parameter representing the optical losses of the optical link concerned.

Thus an optical component transmitted over an optical link having high optical losses is associated with a high transmission optical power whereas an optical component transmitted over an optical link having low optical losses is associated with a low transmission optical power.

According to one feature of the device of an embodiment of the invention, since the optical signal has an overall transmission power distributed in a predetermined way between a plurality of transmission optical powers respectively associated with said optical components, the association means include:

means for ordering said optical components according to their respective transmission power;

means for determining the optical link to be associated with one of said optical components according to said parameter representing the optical losses of said optical link.

In this embodiment of the invention, a transmission optical power is associated arbitrarily with each optical component.

Knowing the transmission optical power associated with each optical component, the link for transmitting the optical component is determined according to the parameter representing its optical losses.

Such an implementation is particularly advantageous when creating an optical network.

According to one feature of the device of an embodiment of the invention, said device also includes means for modifying the distribution of the overall transmission power of said optical signal between said optical components.

Applying a function for distributing the overall transmission power to the optical components of the optical signal imposes a distribution of the overall transmission power between them (for example, a linear power distribution function decreasing with wavelength enabling direct ordering of the optical components according to their respective transmission power). Once the transmission power has been distributed between the optical components, said components are allocated to the optical links according to their requirements.

According to one feature of the device of an embodiment of the invention, said optical components being respectively associated with said optical links and the optical signal having an overall transmission power distributed in a predetermined manner between a plurality of transmission optical powers respectively associated with said optical components, the association means include means for modifying the distribution of the overall transmission power of said optical signal between said optical components according to said parameters representing optical losses of the optical links.

In an existing optical access network, the optical components of the optical signal are already assigned to optical links. As the architecture of the network is fixed, reviewing the assignment of the optical components according to their transmission power, as proposed in the above embodiments of the invention, would have the consequence of a harmful interruption of service and entail the risk of the modification of the architecture causing malfunctions.

Thus it becomes advantageous to be able to adapt the transmission power of the optical components of the optical signal without modifying the architecture of the network.

Adapting the transmission power of an optical component according to a parameter representing the optical losses of the link associated with that optical component makes it possible to offer a user whose optical network unit constitutes one end of the link concerned a satisfactory quality of service, at the same time as optimizing the distribution of the overall transmission power of the transmitting device between the optical components of the transmitted optical signal.

Moreover, this embodiment offers great flexibility when adding a user to or removing a user from the network because it suffices to apply a new optical component transmission power distribution function once the new architecture is in place.

An embodiment of the invention also provides a method of transmitting an optical signal including at least two optical components to be transmitted over at least two respective optical links adapted to be set up between the transmitter device and at least two respective optical network units.

Such a transmission method is noteworthy in that it includes a phase of associating at least one of the optical components, according to a parameter representing optical losses of the optical links with:

an optical link chosen from said optical links; and

a transmission optical power.

According to one feature of the transmission method of an embodiment of the invention, since the optical signal has an overall transmission power distributed in a predetermined way between a plurality of transmission optical powers respectively associated with said optical components, the association phase includes:

a step of ordering said optical components according to their respective transmission power;

a step of determining the optical link to be associated with one of said optical components according to said parameter representing the optical losses of said optical link.

According to one feature of the transmission method of an embodiment of the invention, said method includes before the association phase a step of modifying the distribution of the overall transmission power of said optical signal between said optical components.

According to one feature of the transmission method of an embodiment of the invention, since said optical components are respectively associated with said optical links and since the optical signal has an overall transmission power distributed in a predetermined manner between a plurality of transmission optical powers respectively associated with said optical components, the association phase includes a step of modifying the distribution of the overall transmission power of said optical signal between said optical components according to said parameters representing optical losses of the optical links.

An embodiment of the invention further provides an optical telecommunication central office of an optical access network including at least one device for transmitting an optical signal comprising optical components to be transmitted over at least two respective optical links that can be set up between the transmitter device and at least two respective optical network units.

In such an optical telecommunication central office the transmitter device includes means for associating with at least one of the optical components, according to at least one parameter representing optical losses of the optical links:

an optical link chosen from said optical links; and

a transmission optical power.

An embodiment of the invention finally provides a computer program including program code instructions for executing the steps of the transmission method of the invention when said program is executed by a processor.

### BRIEF DESCRIPTION OF THE DRAWINGS

Other features and advantages become apparent on reading the description of particular embodiments given with reference to the drawings, in which:

FIG. 1 represents a prior art access network of the passive optical network type;

FIG. 2 represents a transmitter device of an embodiment of the invention;

FIG. 3A represents a transmitter device of a first embodiment of the invention;

FIG. 3B is a diagram representing the evolution of transmission power as a function of wavelength of the optical components in the first embodiment of the device of the invention;

FIG. 4A represents a transmitter device of a second embodiment of the invention;

FIGS. 4B and 4C are diagrams representing the evolution of transmission power as a function of wavelength of the optical components in the second embodiment of the device of the invention;

FIG. 5A represents a transmitter device of a third embodiment of the invention;

FIG. 5B is a diagram representing the evolution of transmission power as a function of wavelength of the optical components in the third embodiment of the device of the invention;

FIG. 6A shows an algorithm of a method used in the first embodiment of the invention;

FIG. 6B shows an algorithm of a method used in the second embodiment of the invention;

FIG. 6C shows an algorithm of a method used in the third embodiment of the invention.

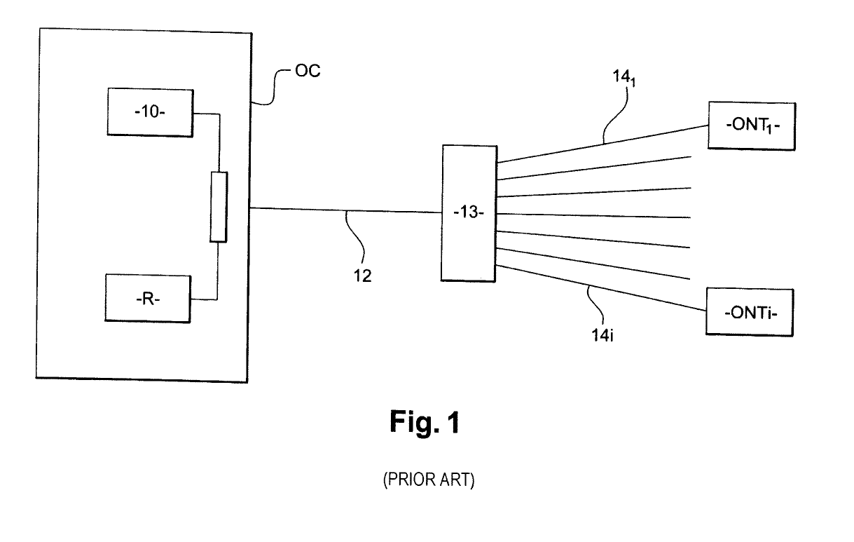

### DETAILED DESCRIPTION OF ILLUSTRATIVE EMBODIMENTS

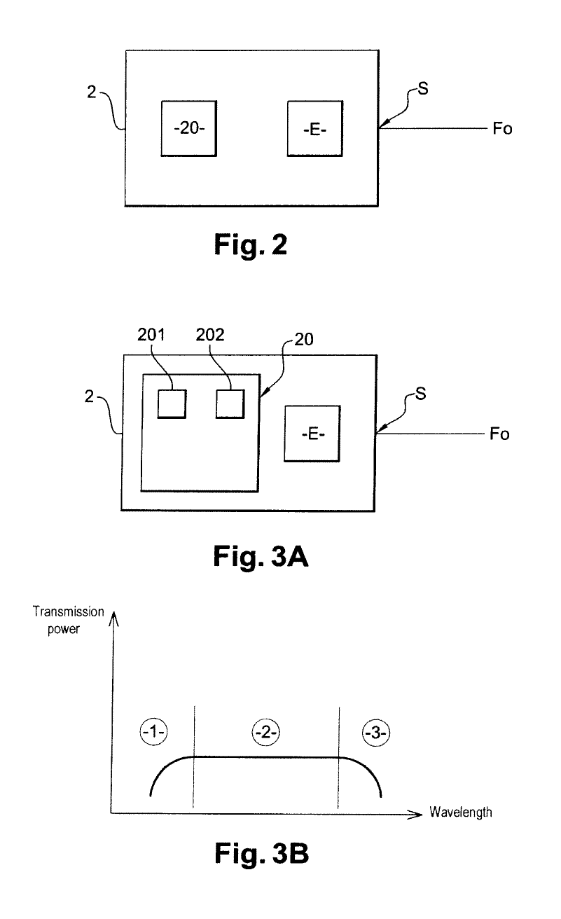

A transmitter device 2 of an embodiment of the invention, as shown in FIG. 2, includes means E for transmitting an optical signal. Such an optical signal includes a plurality of optical components, each associated with a particular wavelength. Such a device 2 is placed in a central office of an optical access network and is intended to be connected to at least one optical link of that network.

The transmitter means E can, for example, consist of a wideband optical source or a plurality of lasers each emitting in a particular band of wavelengths.

A wideband optical source is an optical source transmitting continuously over a broad spectrum of wavelengths. The spectrum of a wideband source is divided into a plurality of spectral bands. Each spectral band constitutes an optical component intended to be transmitted over an optical link.

The diagram representing the overall transmission power as a function of the transmission wavelength of such a source can be divided into three parts, a first part corresponding substantially to short wavelengths, in which power increases with wavelength, a second part in which power is constant regardless of wavelength, and a third part substantially corresponding to long wavelengths, in which power decreases as a function of wavelength. FIG. 3B represents one such diagram.

Conventionally, the wideband source is used in the second part of the diagram, thus assigning the same transmission power to all the optical components independently of the optical link on which they are to be transported.

If the transmitter means E consist of a plurality of lasers, each of the optical components emitted by a laser is transmitted at exactly the same transmission power. Accordingly, just as in the situation of a wideband optical source, the transmission power is constant whatever the wavelength of an optical component.

According to an embodiment of the invention, the transmitter device 2 also includes means 20 for associating an optical component with an optical link and with a transmission optical power according to a parameter representing the optical losses of the optical links of the network.

An output S of the transmitter device 2 is connected to one end of an optical fiber OF constituting an optical link of the optical access network.

In an optical network, all the optical links of the network have optical losses. The optical losses have various causes: the length of the link (the longer the link, the higher are the optical losses); ageing of the fiber constituting the optical link (the older an optical fiber, the higher are its optical losses); the number of optical components present on the link, for example multiplexers; deterioration of the optical fiber, for example by a crack.

Accordingly, each optical link of the optical network has a characteristic parameter representing its optical losses.

The association means 20 make it possible to associate an optical component, an optical link, and a transmission optical power so that the transmission component is transmitted over the associated optical link with a transmission optical power adapted according to the parameter representing the optical losses of the associated optical link.

In order to be able to effect this association, it is necessary for the association means 20 to know for each optical link of the optical network the value of the parameter representing the level of optical losses.

To have access to this information, the central office CO transmits a test optical signal over each of the optical links. This test optical signal is transmitted with a known transmission power. On reception of the test optical signal, each optical network unit measures the received optical power and sends that information to the central office.

For each optical network unit, and consequently for each optical link, the central office compares the optical power received by the optical network unit with the optimum received optical power necessary for the optical network unit to function and deduces from this the level of optical losses of the optical link connecting the central office to the optical network unit.

Accordingly, if an optical link has a high value of the parameter representing the optical losses, then the transmission power of the optical component to be transmitted over the optical link concerned is chosen to compensate the optical losses of the optical link.

The transmission power of the optical components from the transmission means E is adapted without modifying the overall transmission power of the transmitting means E. An embodiment of the invention proposes a rational distribution of the overall transmission power of the transmitter means E between the various optical components according to the requirements of the optical links in which they travel. Accordingly, if an optical component must have its transmission power increased, this is compensated by one or more other optical components having their transmission power reduced. The overall transmission power actually used can be less than the maximum overall transmission power of the transmitter means.

FIG. 3A shows a first embodiment of the transmitter device 2. The components of the transmitter device 2 shared with the embodiment described with reference to FIG. 2 carry the same reference numbers and are not described again. This embodiment of the invention is particularly advantageous if used when creating an optical access network.

In this embodiment, the diagram representing the overall transmission power as a function of the transmission wavelength of the optical component corresponds to the diagram represented in FIG. 3B and described above.

An embodiment of the invention proposes to use the transmitter means E beyond their usable range, i.e. additionally to use wavelengths in the first and third parts of the diagram. In this situation, the distribution of the overall transmission power of the transmitter means is known and each optical component is associated with a particular transmission optical power.

The association means 20 include means 201 for ordering the optical components as a function of their transmission optical power. The optical components can be classified in decreasing order, for example, from those having the highest transmission power to those having the lowest transmission power.

The association means 20 also include means 202 for determining the optical links to be associated with the various optical components. An optical link to be associated with a particular optical component is determined according to the parameter representing the optical losses of the optical link concerned.

In this way an optical component, optical link, and transmission power association is obtained such that the power received by the optical network unit connected to the optical link transmitting the optical component is sufficient to ensure a satisfactory quality of service for the user connected to the optical network unit.

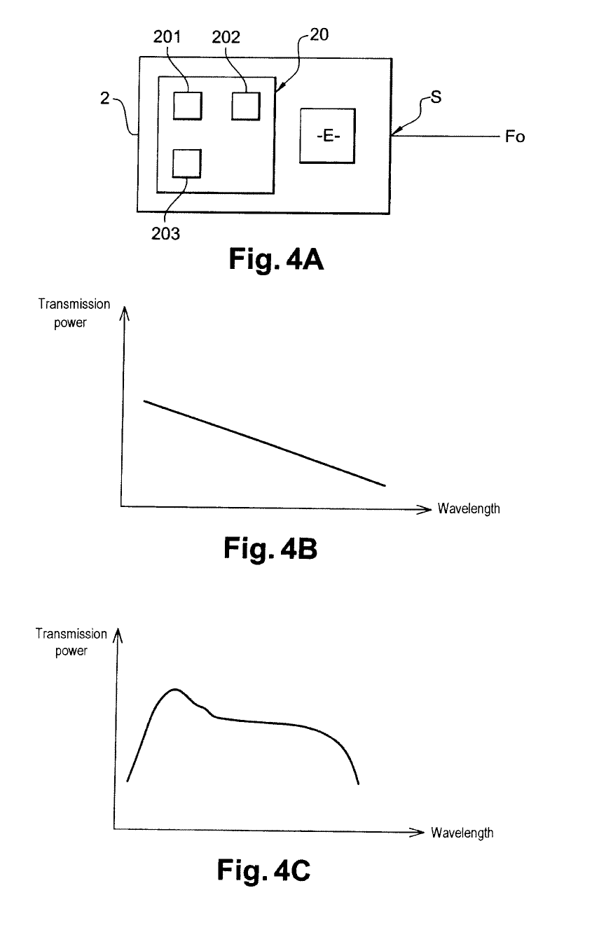

A second embodiment of the transmitter device 2 is represented in FIG. 4A. The components of the transmitter device 2 common to the embodiment described with reference to FIGS. 3A and 3B carry the same references and is not described again. This embodiment is also particularly advantageous to use when creating an optical access network.

The transmitter device 2 further includes means 203 for modifying the distribution of the overall transmission power of the optical signal between the various optical components. A distribution function is applied to a wideband optical source, for example, the diagram of which representing the overall transmission power as a function of the transmission wavelength is represented in FIG. 3B, in order to modify the distribution of the overall transmission power of the optical signal.

After such a distribution function is applied, a diagram is obtained representing overall transmission power as a function of transmission wavelength, as shown in FIG. 4B. The new distribution of the overall transmission power is a straight line with a negative director coefficient. It is possible to obtain other types of profile, for example a profile with a noise hump (see FIG. 4C). The distribution of the overall transmission power of the transmitter means is then known and each optical component is associated with a particular transmission optical power.

When the distribution function has been applied, the optical components are ordered by the ordering means 201, after which the optical links to be associated with the various optical components are determined by the determination means 202.

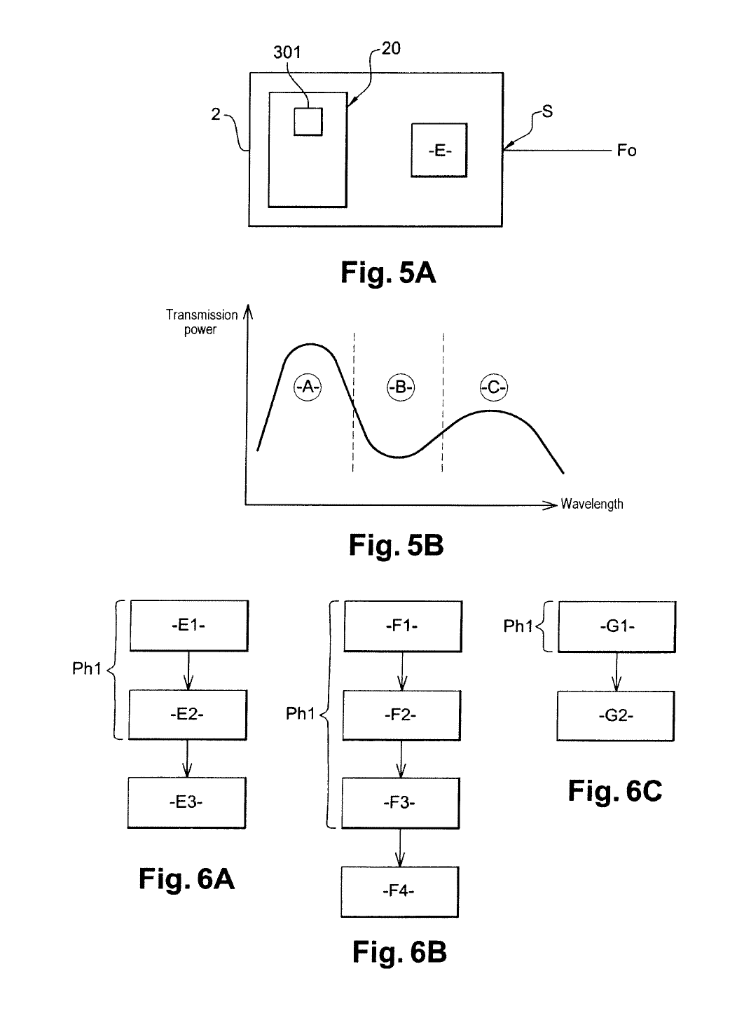

A third embodiment of the transmitter device 2 is represented in FIG. 5A. The components of the transmitter device 2 common to the embodiment described with reference to FIGS. 4A and 4B carry the same references and is not described again.

The transmitter device 2 is connected to a point-to-multipoint optical access network, such as a passive optical network (PON). The transmitter device 2 is thus connected to a plurality of optical network units by the same number of optical links. Each of these optical network units, and consequently each of these optical links, is associated with an optical component when connecting the optical network units to the transmitter device 2. Moreover, the overall transmission power of the transmitter means is divided between the various optical components so that each of them is associated with a particular transmission optical power.

In such a transmitter device 2, the association means 20 include means 301 for modifying the distribution of the overall transmission power of the optical signal between the various optical components according to the parameter representing the optical losses of the optical links associated with the various optical components.

Accordingly, applying a distribution function makes it possible to distribute the overall transmission power between the various optical components according to the requirements of the optical components with which they are associated. The distribution of the overall transmission power is adapted to the architecture of the optical access network.

There is then obtained the diagram shown in FIG. 5B representing the overall transmission power as a function of the transmission wavelength. This diagram is essentially divided into three parts A, B, and C. In part A of the diagram, it is seen that the transmission power of the optical components is high, which signifies that these optical components are associated with optical links having a high value of the parameter representing optical losses. In part B of the diagram, the optical components are associated with optical links having a lower value of the parameter representing the optical losses and are therefore allocated a lower transmission power. Finally, in part C of the diagram, the optical components being associated with optical links having a parameter representing optical losses of lower value than that of the optical links corresponding to part A of the diagram but higher than that of the optical links corresponding to part B of the diagram, said components are assigned a transmission power lower than that allocated to the optical components of the part A of the diagram but higher than that allocated to the optical components of part B of the diagram.

FIG. 6A represents the steps of a transmission method used in a first embodiment of the invention. In this embodiment the overall transmission power of the transmitter means is divided between the various optical components in a manner that is known in the art. Thus each optical component is also associated with a particular transmission optical power.

During a step E1, the optical components are ordered as a function of their respective transmission optical power.

During a step E2, the optical links to be associated with the various optical components are determined as a function of their parameters representing their respective optical losses.

After the step E2, there is obtained an optical component, optical link, and transmission power association such that the power received by the optical network unit connected to the optical link transmitting the optical component is sufficient to ensure a satisfactory quality of service for the user connected to the optical network unit.

The steps E1 and E2 correspond to a phase PH1 of associating an optical component with an optical link and with a transmission optical power, according to a parameter representing the optical losses of the optical links of the network.

After the phase PH1, the optical signal is transmitted by the transmitter means E to the various optical network units during a step E3.

FIG. 6B represents the steps executed by a method used in the second embodiment of the invention. In this embodiment, the overall transmission power of the transmission means is divided between the various optical components in a manner that is known in the art. Thus each optical component is also associated with a particular transmission optical power.

During a step F1 of modifying the overall transmission power distribution of the optical signal between the various optical components, a distribution function is applied to the various optical components of the optical signal. Applying such a distribution function makes it possible to obtain a known distribution of the overall transmission power of the transmission means. Thus each optical component is associated with a particular transmission optical power.

During a step F2, the optical components are ordered as a function of their respective transmission power.

During a step F3, the optical links to be associated with the various optical components are determined according to their parameters representing their respective optical losses.

The steps F1 to F3 correspond to the phase PH1 of modifying the distribution of the overall transmission power of the optical signal.

After the phase PH1, the optical signal is transmitted by the transmitter means E to the various optical network units during a step F4.

FIG. 6C represents the steps executed by a method used in the third embodiment of the invention. In this embodiment, each optical component is associated with a particular optical link and the overall transmission power of the transmitter means is divided between the various optical components in a known manner. Each optical component is therefore also associated with a particular transmission optical power.

During a step G1 of modifying the distribution of the overall transmission power of the optical signal between the various optical components, a distribution function is applied to the various optical components of the optical signal. This function makes it possible to associate with each optical component a transmission power adapted to the parameter representing the optical losses of the optical link with which the optical component is associated.

The step G1 corresponds to the phase PH1 of modifying the distribution of the overall transmission power of the optical signal.

After the phase PH1, the optical signal is transmitted by the transmitter means E to the various optical network units during a step G2.

An embodiment of the invention applies equally to optical networks using wavelength-division multiplexing combined with time-division multiplexing (WDM/TDM networks).

In such a network, the same optical component is shared between a plurality of optical network units. Each optical network unit is connected to the optical central office by an optical link that is specific to it. Thus in a WDM/TDM network the same optical component is associated with at least two different optical links.

In this context, the association means 20 associate with an optical component to be transmitted via a plurality of optical links a transmission optical power adapted to the optical link that has the highest value of the parameter representing the optical losses of all the optical links sharing the optical component.

Finally, an embodiment of the invention also provides a computer program, notably a computer program on or in an information medium or memory, adapted to implement an embodiment of the invention. This program can use any programming language and take the form of source code, object code, or a code intermediate between source code and object code, such as a partially-compiled form, or any form desirable for implementing a method of an embodiment of the invention. When it is executed, this program controls the various means of the transmitter device 2 in order to execute the various steps of the method of an embodiment of the invention.

The information medium can be any entity or device capable of storing the program. For example, the medium can include storage means, such as a ROM, for example a CD ROM or a micro-electronic circuit ROM, or magnetic storage means, for example a floppy disk or a hard disk.

Moreover, the information medium can be a transmissible medium such as an electrical or optical signal, which can be routed via an electrical or optical cable, by radio or by other means. The program of an embodiment of the invention may in particular be downloaded over an Internet-type network.

Although the present disclosure has been described with reference to one or more examples, workers skilled in the art will recognize that changes may be made in form and detail without departing from the scope of the disclosure and/or the appended claims.

1. A transmitter device for transmitting an optical signal comprising at least two optical components to be transmitted over at least two respective optical links adapted to be set up between the transmitter device and at least two respective optical network units, wherein the transmitter device comprises:
means for associating at least one of the optical components, according to at least one parameter representing optical losses of the optical links, with:
at least one optical link chosen from said optical links; and
a transmission optical power.

2. The transmitter device according to claim 1, wherein, since the optical signal has an overall transmission power distributed in a predetermined manner between a plurality of transmission optical powers respectively associated with said optical components, the means for associating include:
means for ordering said optical components according to their respective transmission power; and
means for determining the optical link to be associated with one of said optical components according to said parameter representing the optical losses of said optical link.

3. The transmitter device according to claim 2, further comprising means for modifying the distribution of the overall transmission power of said optical signal between said optical components.

4. The transmitter device according to claim 1, wherein, since said optical components are respectively associated with said optical links and since the optical signal has an overall transmission power distributed in a predetermined manner between a plurality of transmission optical powers respectively associated with said optical components, the means for associating include:
means for modifying the distribution of the overall transmission power of said optical signal between said optical components according to said parameters representing optical losses of the optical links.

5. A transmission method comprising:
transmitting an optical signal comprising at least two optical components over at least two respective optical links adapted to be set up between a transmitter device and at least two respective optical network units; and
a phase of associating with at least one of the optical components, according to a parameter representing optical losses of the optical links:
an optical link chosen from said optical links; and
a transmission optical power.

6. The transmission method according to claim 5, wherein, since the optical signal has an overall transmission power distributed in a predetermined way between a plurality of transmission optical powers respectively associated with said optical components, the association phase includes:
a step of ordering said optical components according to their respective transmission power; and
a step of determining the optical link to be associated with one of said optical components according to said parameter representing optical losses of said optical link.

7. The transmission method according to claim 6, further comprising:
before the association phase a step of modifying the distribution of the overall transmission power of said optical signal between said optical components.

8. A transmission method according to claim 5, wherein, since said optical components are respectively associated with said optical links and since the optical signal has an overall transmission power distributed in a predetermined manner between a plurality of transmission optical powers respectively associated with said optical components, the association phase includes:
a step of modifying the distribution of the overall transmission power of said optical signal between said optical components according to said parameters representing optical losses of the optical links.

9. An optical telecommunication central office of an optical access network, wherein the central office comprises:
at least one transmitter device for transmitting an optical signal comprising at least two optical components to be transmitted over at least two respective optical links that can be set up between the transmitter device and at least two respective optical network units; wherein the transmitter device includes means for associating at least one of the optical components, according to at least one parameter representing optical losses of the optical links with:
an optical link chosen from said optical links; and
a transmission optical power.

10. A computer program stored on a non-transitory medium and comprising program code instructions for executing a transmission method when said program is executed by a processor, wherein the transmission method comprises:
transmitting an optical signal comprising at least two optical components over at least two respective optical links adapted to be set up between a transmitter device and at least two respective optical network units; and
a phase of associating with at least one of the optical components, according to a parameter representing optical losses of the optical links:
an optical link chosen from said optical links; and
a transmission optical power.
